(19) United States
(12) Patent Application Publication
(10) Pub. No.: US 2012/0250861 A1
(43) Pub. Date: Oct. 4, 2012

(54) BROADCAST RECEPTION TERMINAL AND BROADCAST RECEPTION METHOD

(75) Inventors: Koji Ishii, Zushi-shi (JP); Nobuaki Sasao, Kawasaki-shi (JP)

(73) Assignee: NTT DOCOMO, INC, Chiyoda-ku, Tokyo (JP)

(21) Appl. No.: 13/510,025

(22) PCT Filed: Sep. 6, 2010
(86) PCT No.: PCT/JP2010/065238

§ 371 Date: Jun. 18, 2012

(30) Foreign Application Priority Data
Nov. 16, 2009 (JP) 2009-260927

(51) Int. Cl. H04N 7/167

(52) U.S. Cl. 380/210

(57) ABSTRACT

A broadcast receiving terminal includes a conditional access system (CAS) module that acquires key information from a broadcast signal and a renderer that plays back video/audio data in the broadcast signal. The CAS module includes a history information storage unit that stores playback history information and a playback time calculation unit that calculates playback remaining time information related to the video/audio data and sends a scrambling key and the playback remaining time information to the renderer. The renderer includes a descrambling unit and a decoding unit that decrypts the video/audio with the scrambling key to play them back and send history information related to the playback to the CAS module and a preview control unit that performs control to decrypt the video/audio data only for the time indicated by the playback remaining time information. The terminal achieves playback control in accordance with an actual playback time.

### TECHNICAL FIELD

The present invention relates to a broadcast receiving terminal and a broadcast receiving method for receiving and playing back broadcast data.

### BACKGROUND ART

Conventionally, in devices that receive broadcast signals for digital broadcasting or the like, mechanisms for receiving pay broadcast programs are provided. As one of such mechanisms, a preview function for providing a pay broadcast program for a given period of time for free is known.

For example, in a broadcast receiving device described in Patent Literature 1 mentioned below, the following functions are provided. Specifically, this broadcast receiving device periodically receives information, referred to as an entitlement control message (ECM), included in broadcast signals, then a security module structured with an IC card and the like incorporated in the broadcast receiving device acquires information such as a “scrambling key” and a “preview-permitted time” included in the ECM, and manages a preview time concerning playback data that is being received based on the preview-permitted time. Furthermore, the security module measures a remaining time of the preview-permitted time with a counter, and controls the device so as to output the scrambling key to a main unit of the broadcast receiving device in accordance with the remaining time. Accordingly, the main unit of the broadcast receiving device, in accordance with the preview-permitted time, can descramble (decrypt) with the scrambling key video/audio information (playback data) multiplexed into broadcast signals and play back the playback data thus descrambled. In addition, in Patent Literature 2 mentioned below, a technique for managing a preview time in an IC card to control output of a scrambling key is described.

Herein, the ECM in which the scrambling key is included is periodically (e.g., at intervals of one second) updated and transmitted from a broadcasting station, and the above-mentioned security module of the broadcast receiving device has a function of, every time the ECM is updated, extracting a new scrambling key from the ECM and outputting it to the main unit of the broadcast receiving device. With such a function, it becomes possible to descramble video/audio information continuously even if the scrambling key is updated.

### CITATION LIST

### Patent Literature

[Patent Literature 1] Japanese Patent Application Laid-Open Publication No. 11-308595
[Patent Literature 2] Japanese Patent Application Laid-Open Publication No. 2003-264813

### SUMMARY OF INVENTION

### Technical Problem

However, in broadcast receiving methods described in the above mentioned Patent Literatures 1 and 2, when an updating interval of a key for decrypting video/audio information is short to some extent (e.g., one second), playback control is possible in a unit of the updating interval but, when the updating interval is long, because a time during which playback is possible with the same key becomes longer, playback control at short time intervals tends to be difficult. In other words, once a key for decryption is output from the security module, playback becomes possible with a broadcast receiving device during the updating interval of the key without restriction. Meanwhile, when it is desired to improve cryptographic strength of broadcast data, or in order to secure an operation time in accordance with processing capability of a security module such as an IC card and lower the power consumption, a need to set the updating interval longer presents itself.

Accordingly, the present invention is made in view of these problems to be solved, and aims to provide a broadcast receiving terminal and a broadcast receiving method that are capable of implementing playback control in accordance with an actual playback time without being affected by the updating frequency of a decryption key for playback data to be broadcasted.

### Solution to Problem

To solve the above-mentioned problems, a broadcast receiving terminal of the present invention includes a key information processing unit that receives a broadcast signal and acquires key information out of the broadcast signal, and a playback data processing unit that decrypts playback data included in the broadcast signal by using the key information and plays the resulting data back, wherein the key information processing unit includes history information storage means for storing history information on playback of the playback data by the playback data processing unit; and calculation means for acquiring the key information and playback time information indicating a time during which playback of the playback data is possible that are included in the broadcast signal, calculating playback remaining time information indicating a remaining time during which playback of the playback data is possible based on the playback time information and the history information, and sending the key information and the playback remaining time information to the playback data processing unit; and the playback data processing unit includes decrypting means for decrypting the playback data included in the broadcast signal by using the key information sent from the calculation means and playing it back, and sending history information on this playback to the key information processing unit; and playback control means for controlling the decrypting means so as to decrypt the playback data only for the time indicated by the playback remaining time information sent from the calculation means.

In addition, a broadcast receiving method of the present invention is a broadcast receiving method in a broadcast receiving terminal including a key information processing unit that receives a broadcast signal and acquires key information out of the broadcast signal, and a playback data processing unit that decrypts playback data included in the broadcast signal by using the key information and plays the resulting data back, and includes a history information storage step of, by the key information processing unit, storing history information on playback of the playback data by the playback data processing unit; a calculation step of, by the key information processing unit, acquiring the key information and playback time information indicating a time during which playback of the playback data is possible that are included in the broadcast signal, calculating playback remaining time information indicating a remaining time during which playback of the playback data is possible based on the playback time information and the history information, and sending the key information and the playback remaining time information to the playback data processing unit; a decrypting step of, by the playback data processing unit, decrypting the playback data included in the broadcast signal by using the key information sent from the key information processing unit and playing the resulting data back, and sending history information on this playback to the key information processing unit; and a playback control step of, by the playback data processing unit, performing control so as to decrypt the playback data only for the time indicated by the playback remaining time information sent from the key information processing unit.

In the broadcast receiving terminal and the broadcast receiving method, the history information on playback of the playback data is stored in the history information storage means of the key information processing unit, and the calculation means of the key information processing unit, when acquiring the key information and the playback time information included in the broadcast signal, calculates the playback remaining time information from the playback time information and the history information, and sends the playback remaining time information together with the key information to the playback data processing unit. In response to this, the playback control means of the playback data processing unit controls the decrypting means so as to decrypt the playback data by using the key information only for the time that the playback remaining time information indicates, and the decrypting means of the playback data processing unit decrypts and plays back the playback data in accordance with this control, and also sends the history information on this playback to the key information processing unit. In this manner, on the side of the playback data processing unit that performs a decrypting process and a playback process of the playback data, decrypting control of the playback data on the basis of the playback remaining time information is performed, and accordingly, without being affected by the updating interval of the key information, playback control with high temporal accuracy is implemented. Furthermore, because the playback remaining time is calculated based on the history of playback by the playback data processing unit, the playback control corresponding to the actual playback time becomes possible.

### Advantageous Effects of Invention

According to the present invention, without being affected by the updating frequency of the decryption key for playback data to be broadcasted, it is possible to implement the playback control in accordance with the actual playback time.

### BRIEF DESCRIPTION OF DRAWINGS

FIG. 1 is a schematic block diagram of a broadcast receiving terminal according to one preferred embodiment of the present invention.

FIG. 2 is a diagram illustrating a hardware structure of the broadcast receiving terminal in FIG. 1.

FIG. 3 is a diagram illustrating a data structure of ECM data that a separation unit in FIG. 1 separates.

FIG. 4 is a diagram illustrating a data structure of viewing history information stored in a viewing history information storage unit in FIG. 1.

FIG. 5 is a sequence diagram illustrating normal operation at the time of preview execution of a pay broadcast program in the broadcast receiving terminal in FIG. 1.

FIG. 6 is a sequence diagram illustrating abnormal operation at the time of preview execution of a pay broadcast program in the broadcast receiving terminal in FIG. 1.

FIG. 7 is a timing chart illustrating updating timing of a conventional scrambling key.

FIG. 8 is a sequence diagram illustrating operation at the time of preview execution of a pay broadcast program in the broadcast receiving terminal of a modified example of the present invention.

FIG. 9 is a sequence diagram illustrating operation at the time of preview execution of a pay broadcast program in the broadcast receiving terminal of a modified example of the present invention.

### DESCRIPTION OF EMBODIMENTS

Hereinafter, preferable embodiments of a broadcast receiving terminal and a broadcast receiving method according to the present invention will be described in detail with reference to the drawings. Note that like reference signs are given to like parts for description of the drawings, and redundant explanations are omitted.

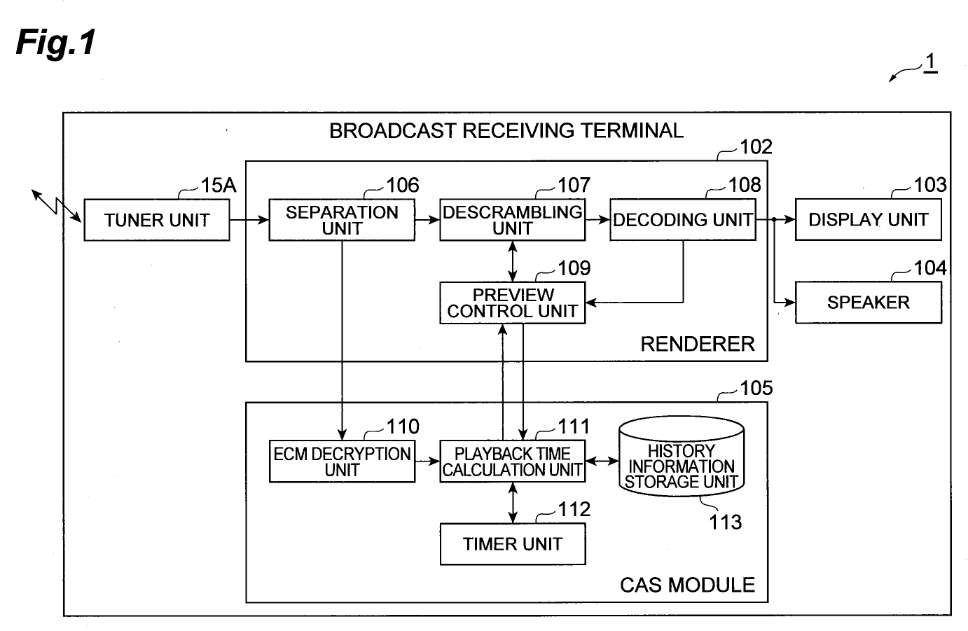

FIG. 1 is a schematic block diagram of a broadcast receiving terminal 1 according to one preferred embodiment of the present invention. The broadcast receiving terminal 1 according to the present embodiment depicted in FIG. 1 is a data processing terminal such as a mobile phone, a personal computer, or a personal digital assistant (PDA) that complies with standards such as Association of Radio Industries and Businesses (ARIB) STD-B20 and can receive a pay digital program.

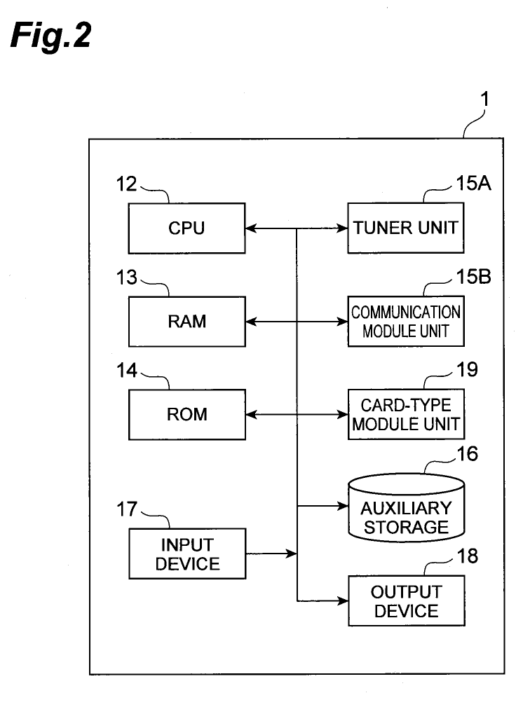

As depicted in FIG. 2, the broadcast receiving terminal 1 is physically configured as an information processing device that includes a CPU 12, a RAM 13 and a ROM 14 being main memories, an auxiliary storage 16 such as a hard disk drive, an input device 17 such as an input key and a mouse being input devices, an output device 18 such as a display and a speaker, a tuner unit 15A receiving digital broadcast signals (radio waves), a communication module unit 15B that manages transmission and reception of data by a mobile communication method, and a card-type module unit 19 such as an IC card that incorporates a memory circuit and an arithmetic circuit. Functions implemented by the broadcast receiving terminal 1, by loading a predetermined program into hardware such as the CPU 12, the RAM 13 depicted in FIG. 2 to cause the tuner unit 15A, the communication module unit 15B, the input device 17, and the output device 18 to operate under control of the CPU 12, and also by performing read and write of data in the RAM 13 or the auxiliary storage 16, are implemented. In addition, the CPU 12 is made capable of exchanging data with the card-type module unit 19, and the card-type module unit 19 is made capable of implementing a predetermined function by operating a program that is stored in the memory circuit inside in advance, and also storing therein the data received from the CPU 12.

Subsequently, referring back to FIG. 1, the functions of the broadcast receiving terminal 1 will be described in detail.

To begin with, the broadcast receiving terminal 1 includes the tuner unit 15A, a display unit 103 and a speaker 104 constituting the output device 18, a renderer (playback data processing unit) 102 that decrypts and plays back playback data included in a broadcast signal, and a conditional access system (CAS) module (key information processing unit) 105 that is the card-type module unit 19 acquiring key information for decryption of the playback data out of the broadcast signal. More specifically, this renderer 102 is structured with a separation unit 106, a descrambling unit (decrypting means) 107, a decoding unit (decrypting means) 108, and a preview control unit (playback control means) 109, and the CAS module 105 is structured with an ECM decryption unit 110, a playback time calculation unit (calculation means) 111, a timer unit (measuring means) 112, and a history information storage unit (history information storage means) 113.

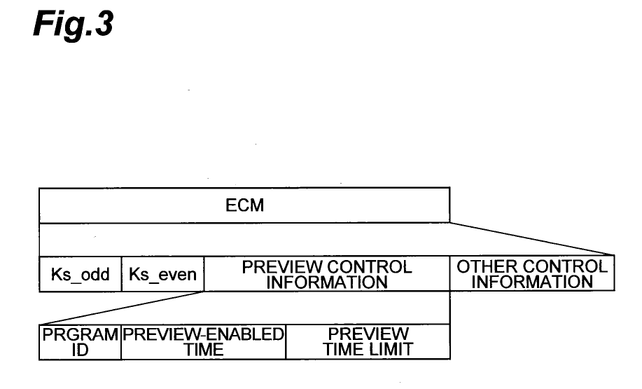

The separation unit 106 of the renderer 102, out of multiplexed data referred to as a transport stream (TS) that is included in the broadcast signal and received by the tuner unit 15A, separates video/audio data and ECM data. This separation unit 106 sends the video/audio data separated to the descrambling unit 107, and the ECM data separated to the ECM decryption unit 110 of the CAS module 105, respectively. FIG. 3 illustrates a data structure of the ECM data that the separation unit 106 separates. As depicted in this drawing, the ECM data separated from the TS includes two “scrambling keys (decryption key information) Ks_odd and Ks_even” for decrypting the video/audio data encrypted on the TS, “preview control information” for controlling a time of free playback intended for the video/audio data, and “other control information” that is contract determination information for determining availability of playback of the video/audio data on the basis of contract information of a user. This “preview control information” is configured to include a “program ID” for identifying a broadcast program corresponding to video/audio data, a “preview-enabled time” (playback time information) indicating a period during which preview playback of the video/audio data is permitted, and a “preview time limit” (playback time information) indicating a time limit until which preview playback is possible.

The ECM decryption unit 110 of the CAS module 105, after decrypting the ECM data separated by the separation unit 106 by using a work key Kw that is stored in the CAS module 105 in advance, acquires out of the ECM data the scrambling keys Ks_odd and Ks_even, the preview control information, and the other control information and sends them to the playback time calculation unit 111.

In response to this, the playback time calculation unit 111, based on history information on playback of the video/audio data by the renderer 102 and the preview control information acquired by the ECM decryption unit 110, calculates playback remaining time information indicating a remaining time during which the preview of a broadcast program selected by the tuner unit 15A is possible.

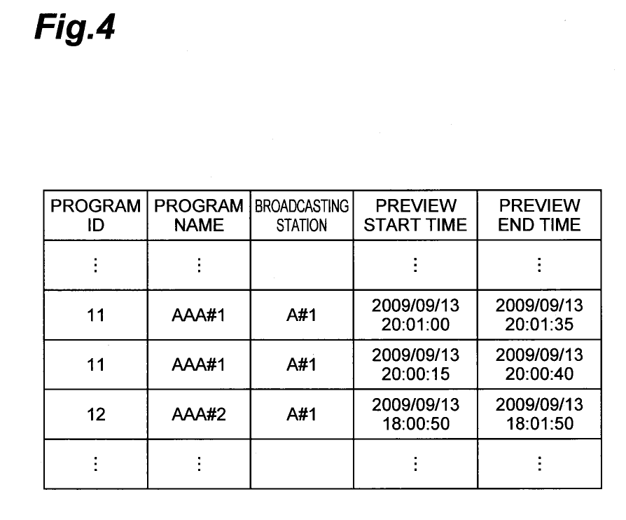

This history information has a data structure depicted in FIG. 4, is sequentially generated in accordance with start and stop of preview playback of the broadcast program by the renderer 102, and is stored in the history information storage unit 113 in the CAS module 105 in advance. More specifically, included in the history information are “program IDs”, “program names”, and “broadcasting stations” for identifying each of broadcast programs a preview of which is to be played back, and “preview start time” and “preview end time” that indicate time periods when the broadcast programs were played back. Alternatively, information indicating preview playback time periods stored in the history information storage unit 113 may be, instead of the start time and the end time, information indicating the lengths of playback periods, such as “playback time: 60 seconds”.

In addition, the playback time calculation unit 111 reads pieces of history information that include a program ID corresponding to the program ID included in the preview control information from the history information storage unit 113, and calculates a total time of already-played-back periods from the pieces of history information thus read. For example, in an example depicted in FIG. 4, the playback time calculation unit 111, for the “program ID: 11” included in the preview control information, calculates the sum of playback periods for two times and obtains “35 seconds”+“25 seconds”=“60 seconds”. Alternatively, it is acceptable to, as the pieces of history information to be added up, use those within a predetermined time period such as the latest one day period to be calculated.

Furthermore, the playback time calculation unit 111 calculates the playback remaining time information by subtracting the sum of playback periods obtained in the above-described manner from the preview-enabled time included in the preview control information. For example, the playback time calculation unit 111, when the preview-enabled time is “120 seconds” and the sum of already-played-back periods is “60 seconds”, calculates the playback remaining time information and obtains 120 seconds−60 seconds=“60 seconds”. In addition, the playback time calculation unit 111 also calculates a time period from the present time to the preview time limit included in the preview control information, and determines shorter one out of this time period and a time that the playback remaining time information indicates as a playback remaining time information. Then, the playback time calculation unit 111 sends the scrambling keys Ks_odd and Ks_even acquired by the ECM decryption unit 110 and the playback remaining time information thus determined to the preview control unit 109 of the renderer 102.

In addition, the playback time calculation unit 111 has a function of, based on a playback history concerning the broadcast program received from the preview control unit 109 of the renderer 102, storing the history information in the history information storage unit 113. In addition, the playback time calculation unit 111 uses the timer unit 112 to measure an elapsed time after the point when outputting the scrambling keys Ks_odd, Ks_even and the playback remaining time information to the renderer 102, and by comparing the elapsed time with the playback remaining time information, detects an invalid playback process of video/audio data by the renderer 102. Then, the playback time calculation unit 111, when having detected the invalid playback process, aborts output of the scrambling keys Ks_odd and Ks_even and the playback remaining time information to the renderer 102. For example, the playback time calculation unit 111, despite the fact that the playback remaining time is “60 seconds”, when the elapsed time measured by the timer unit 112 is “70 seconds” exceeding the playback remaining time, determines that invalid playback is performed by the renderer 102, and by setting a playback time that the playback history indicates at a large value such as an upper limit and storing it therein, aborts the subsequent output of the scrambling keys Ks_odd and Ks_to the renderer 102.

The descrambling unit 107 of the renderer 102, using the scrambling keys Ks_odd and Ks_even sent by the CAS module 105 via the preview control unit 109, descrambles (decrypts) the video/audio data separated by the separation unit 106 by a MULTI2 encryption method, for example. The video/audio data thus descrambled is sent to the decoding unit 108. Note that start and end of this descrambling process by the descrambling unit 107 are controlled by the preview control unit 109.

The decoding unit 108, by decoding the video/audio data sent from the descrambling unit 107 after the descrambling process into a playback-enabled data format and outputting the video/audio data thus decoded to the display unit 103 and the speaker 104, plays back the data as an image and a sound. In addition, the decoding unit 108, when starting and ending the playback process of the video/audio data, informs the preview control unit 109 of the timings thereof.

The preview control unit 109 uses the scrambling keys Ks_odd and Ks_even and the playback remaining time information received from the CAS module 105 to control the start and the end of the playback process by the descrambling unit 107 and the decoding unit 108. More specifically, the preview control unit 109, by outputting the scrambling keys Ks_odd and Ks_even to the descrambling unit 107, controls the descrambling unit 107 and the decoding unit 108 so as to cause them to start the descrambling process and the playback process intended for the video/audio data, continue the descrambling and the playback only for a duration that the playback remaining time information indicates, and end the descrambling and the playback after the elapse of the duration. Herein, the two scrambling keys Ks_odd and Ks_even received from the CAS module 105 are used for descrambling the video/audio data, alternately at each key update cycle (details will be described later). In addition, the preview control unit 109, in response to a notification from the decoding unit 108, generates a playback history based on the start time and the end time of the preview playback process, and sends the playback history to the CAS module 105.

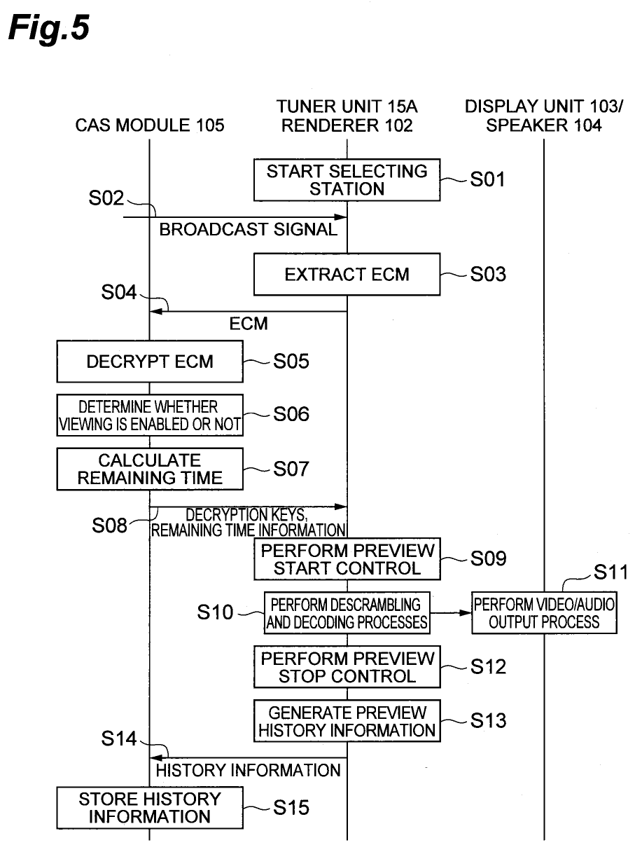

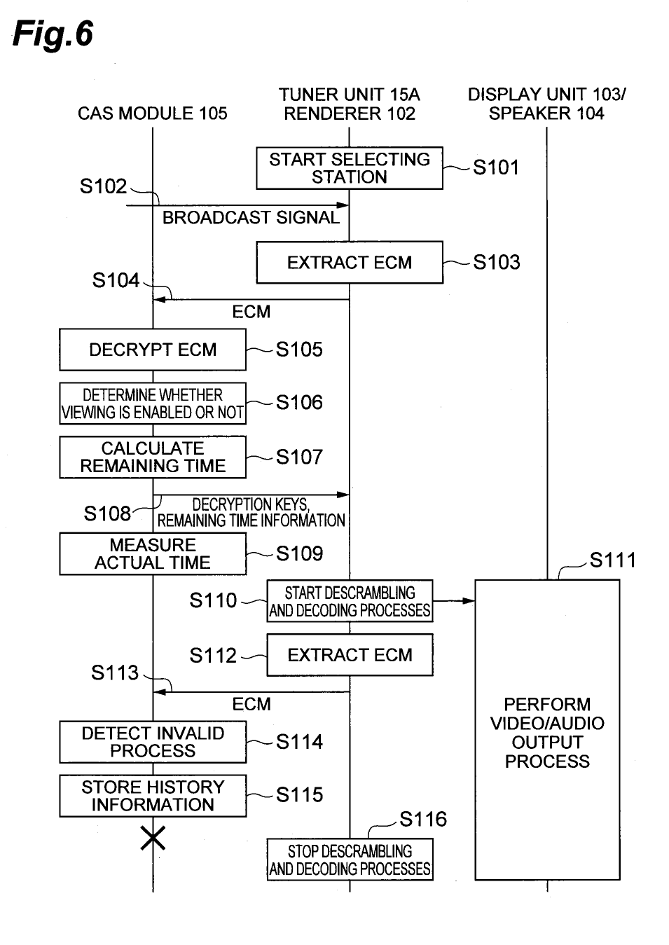

Hereinafter, referring to FIG. 5 and FIG. 6, operation of the broadcast receiving terminal 1 will be explained, and also a broadcast receiving method in the broadcast receiving terminal 1 will be described in detail. FIG. 5 is a sequence diagram illustrating normal operation at the time of preview execution of a pay broadcast program in the broadcast receiving terminal 1, and FIG. 6 is a sequence diagram illustrating abnormal operation at the time of preview execution of a pay broadcast program in the broadcast receiving terminal 1.

To begin with, referring to FIG. 5, when a broadcasting station that a user wants to watch is selected in the broadcast receiving terminal 1, a TS is acquired from a broadcast signal by the tuner unit 15A (steps S01 to S02). Next, by the separation unit 106 of the renderer 102, video/audio data and ECM data are separated and extracted from the TS (step S03).

The ECM data thus extracted is sent to the ECM decryption unit 110 of the CAS module 105 (step S04) and, in response to this, the ECM data is decrypted with a work key Kw by the ECM decryption unit 110, and scrambling keys Ks_odd and Ks_even, preview control information, and other control information included in the ECM data are sent to the playback time calculation unit 111 (step S05).

Then, the playback time calculation unit 111, by checking contract determination information included in the ECM data against contract information that is stored in the CAS module 105 in advance, determines whether preview playback of the broadcast program that is currently being received on the TS is permitted or not (step S06). When the preview playback is permitted, the playback time calculation unit 111, by referring to the preview control information and history information stored in the history information storage unit 113, calculates playback remaining time information indicating a remaining time during which the preview playback of the broadcast program is possible (step S07). Subsequently, the playback time calculation unit 111 sends the playback remaining time information together with the scrambling keys Ks_odd and Ks_even to the renderer 102 (step S08).

In response to this, the preview control unit 109 of the renderer 102, so as to start a descrambling process intended for the video/audio data separated from the TS by alternately using the scrambling keys Ks_odd and Ks_even, controls the descrambling unit 107 (step S09), thereby causing the descrambling unit 107 to start the preview playback of the video/audio data. Then, the preview control unit 109, by controlling the descrambling unit 107 so as to cause it to continue the descrambling process of the video/audio data only for a period that the playback remaining time information indicates (step S10), causes the display unit 103 and the speaker 104 to play back the video/audio data (step S11). Subsequently, after the time that the playback remaining time information indicates has elapsed, the preview control unit 109, controls the descrambling unit 107 so as to cause it to stop the descrambling process (step S12), thereby causing the descrambling unit 107 to stop the preview playback of the video/audio data. At the same time, the preview control unit 109, in response to a notification from the decoding unit 108, generates a playback history including start time and end time of the preview playback (step S13), and sends the playback history to the CAS module 105 (step S14). Herein, the playback history may be prepared at the timing when the descrambling process has started or ended, or may be prepared, in consideration of a processing time of the descrambling process and a decoding process, at the timing when the output of an image and a sound to the display unit 103 and the speaker 104 has started or the output thereof has ended. In addition, the preview control unit 109 may control the descrambling unit 107 so as to cause it to receive preview time limit information other than the playback remaining time information from the CAS module 105 and stop the descrambling process at the time that this preview time limit information indicates.

Finally, in the history information storage unit 113 of the CAS module 105, the playback history generated by the renderer 102 is stored (step S15). Note that, when the preview playback is ended by the renderer 102 before the elapse of the time that the playback remaining time information indicates (when a channel tuning instruction to another broadcasting station or a playback end instruction are given by a user), a playback history in accordance with an actual time thereof is stored. In a manner described above, for each request for preview playback of video/audio data at one time from a user, control of a preview playback time is performed.

Subsequently, referring to FIG. 6, an abnormal operation with an invalid playback process by the renderer 102 detected will be described. To begin with, in the same manner as the processes at steps S01 to S08 in FIG. 5, in response to the reception of a broadcast signal by the tuner unit 15A, scrambling keys and playback remaining time information are output from the CAS module 105 to the renderer 102 (steps S101 to S108). At the same time, by the timer unit 112 of the CAS module 105, measurement of an elapsed time after outputting the scrambling keys is started (step S109).

In response to this, by the renderer 102, a descrambling process and a decoding process intended for video/audio data with the scrambling keys Ks_odd and Ks_even are performed (step S110), and an image and a sound are output to the display unit 103 and the speaker 104 (step S111). Herein, the scrambling keys Ks_odd and Ks_even are updated in a predetermined cycle and broadcasted as ECM data from a broadcasting station, and the ECM data that is synchronized at the update cycle and newly received is sent to the CAS module 105 after being extracted by the separation unit 106 (steps S112 to S113).

At the timing when the ECM data is sent, the playback time calculation unit 111 of the CAS module 105, by determining whether the elapsed time measured by the timer unit 112 exceeds the playback remaining time calculated at step S107 or not, detects invalid preview playback by the renderer 102 (step S114). As a result of the determination, when the elapsed time exceeds the playback remaining time, the playback time calculation unit 111, by setting the playback time that the playback history indicates to the upper limit and storing it, aborts the subsequent output of the scrambling keys Ks_odd and Ks_even to the renderer 102 (step S115). Accordingly, a descrambling process and a decoding process that are performed by the renderer 102 and are invalid are stopped (step S116).

In the broadcast receiving terminal 1 and the broadcast receiving method using it described above, the history information on preview playback of the video/audio data is stored in the history information storage unit 113 of the CAS module 105, and the playback time calculation unit 111 of the CAS module 105, when acquiring the scrambling keys and the playback time information included in the broadcast signal, from the playback time information and the history information stored in the history information storage unit 113, calculates the playback remaining time information on the broadcast program that is being received, and sends the playback remaining time information together with the scrambling keys to the renderer 102. In response to this, the preview control unit 109 of the renderer 102 controls the descrambling unit 107 so as to decrypt video/audio data that is being broadcasted by using the scrambling keys only for a time that the playback remaining time information indicates, and the descrambling unit 107 and the decoding unit 108 decrypts and plays back the video/audio data in accordance with this control, and also sends the history information on the playback to the CAS module 105. In this manner, on the side of the renderer 102 that performs a decrypting process and a playback process of the video/audio data, decryption control of the video/audio data on the basis of the playback remaining time information is performed, and accordingly, without being affected by the updating interval of the scrambling keys, playback control with high temporal accuracy is implemented. Furthermore, because the playback remaining time is calculated based on a playback history by the renderer 102, the playback control corresponding to the actual playback time becomes possible.

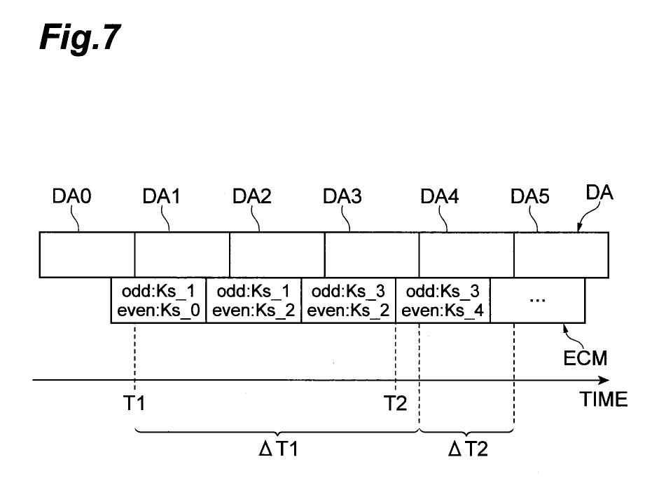

Effects of the above-described control of the preview playback that is not affected by the key update cycle will be described in more detail. In digital broadcast complying with standards such as ARIB STD B25 and ARIB TR B14, to make encrypted video/audio data included in a TS capable of being decrypted, two scrambling keys Ks_odd and Ks_even are set in ECM data included in the TS, and these two scrambling keys Ks_odd and Ks_even, in consideration of a processing capacity of the CAS module structured with an IC card and the like, are updated alternately in a predetermined update cycle. For example, as depicted in FIG. 7, video/audio data DA, being divided into a plurality of pieces of data DA0, DA1, . . . encrypted with different scrambling keys and multiplexed into a TS, is broadcasted, and the ECM data including the two scrambling keys Ks_odd and Ks_even, being shifted to the broadcast timing of these pieces of data DA0, DA1, . . . and updated, is broadcasted. The scrambling keys Ks_odd and Ks_included in the ECM data are alternately updated every time the ECM data is updated, a new scrambling key is set to the scrambling key Ks_even at given updating timing, and new key data is set to the scrambling key Ks_odd at the next updating timing. Then, so as to be able to start a descrambling process immediately after selecting a broadcasting station, by alternately using two scrambling keys Ks_0 and Ks_1 that are obtained by ECM data reception at one time, it is configured to be able to descramble two pieces of consecutive video/audio data DA0 and DA1.

With respect to an update cycle of the ECM data, use of an encryption method such as 64-bit block cipher whose processing load is relatively light makes, even when using an IC card whose arithmetic processing capability is not so high, possible problems associated with the update cycle set to a short period of about two seconds negligible. However, use of a block cipher of 128 bit or 256 bit for the purpose of increasing the cryptographic strength for a digital broadcast makes, considering the processing capability or the power consumption of the IC card, it necessary to set the update cycle of the ECM data longer (e.g., 10 seconds to 1 minute). In this case, managing a playback-permitted time in the CAS module and outputting the scrambling keys to the renderer as in a conventional manner would lead to a result in which overtime of preview playback that the side of a broadcasting station does not intend is permitted. For example, in an example of FIG. 7, before the original preview-permitted time ΔT1 has elapsed (at time T2) after the initial scrambling keys Ks_0 and Ks_1 were received at time T1, updated scrambling keys Ks_3 and Ks_4 are made capable of being acquired by the renderer, and accordingly preview playback of the data DA4 by using this scrambling key Ks_4 becomes possible, generating an excess of playback time of time ΔT2. In other words, conventionally, the preview control has been implemented only at update cycle intervals of keys.

In contrast, with the broadcast receiving terminal 1, because the preview control unit 109 of the renderer 102, based on the playback remaining time information sent from the CAS module 105, controls the preview playback time, even when the update cycle of the scrambling keys becomes longer, the playback control in accordance with the playback time set in the ECM data is implemented, in which an excessive time does not occur. Furthermore, by using the preview playback history by the renderer 102 to calculate a playback remaining time, control of an accurate playback time becomes possible regardless of the update cycle of the scrambling keys.

In addition, when an elapsed time after the output of the scrambling keys by the CAS module 105 exceeds the playback remaining time, by stopping the preview playback performed by the renderer 102, it is possible to surely prohibit invalid preview playback performed by an invalid renderer. In this case, when the CAS module 105 is delivered to the user of the broadcast receiving terminal from a broadcasting organization and the renderer 102 is developed by various terminal manufacturers, an invalid process due to intentional implementation of an invalid function, failure of a function, or the like is prevented.

Note that the present invention is not limited to the above-described embodiments. For example, as described in the foregoing, because the scrambling keys for preview playback are updated in a predetermined update cycle, as long as the playback remaining time is left after the preview playback by the renderer 102 is started, it is acceptable to repeat the output of the scrambling keys from the CAS module 105 to the renderer 102.

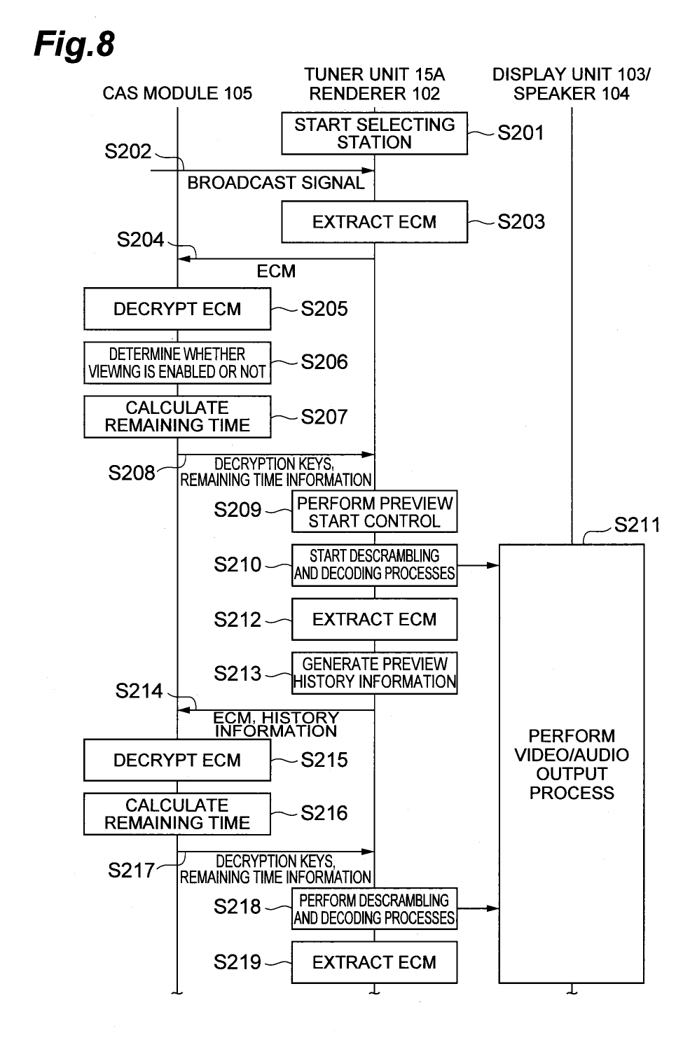

FIG. 8 is a sequence diagram illustrating operation at the time of preview execution of a pay broadcast program in the broadcast receiving terminal 1 in such a case. To begin with, in the same manner as the processes at steps S01 to S11 in FIG. 5, in accordance with reception of a broadcast signal by the tuner unit 15A, scrambling keys and playback remaining time information are output from the CAS module 105 to the renderer 102, and accordingly the preview playback is started by the renderer 102 (steps S201 to S211). Subsequently, in synchronization with the update timing of the ECM data, the ECM data updated is received by the tuner unit 15A, and the ECM data is extracted by the separation unit 106 (step S212). Next, a playback history of the preview playback at this point is generated by the renderer 102 (step S213), and this playback history and the ECM data are sent from the renderer 102 to the CAS module 105. In response to this, by the CAS module 105, decryption of the ECM data (step S215) and calculation of playback remaining time information (step S216) are repeated again, and new scrambling keys and playback remaining time information are sent to the renderer 102 (step S217). Subsequently, by the renderer 102, the preview playback process is continued using the new scrambling keys (steps S218 and S211). After this, in synchronization with the update timing of the ECM data, the update of the scrambling keys and the preview playback process using the updated keys are repeated (step S219 and after).

In this manner, by repeatedly outputting the scrambling keys and the playback remaining time information from the CAS module 105 to the renderer 102 in synchronization with the update cycle of the scrambling keys, continuous playback control in accordance with the playback-permitted time becomes possible without being affected by the update cycle of the keys. Alternatively, at step S214 in FIG. 8, when only the ECM data is sent from the renderer 102 to the CAS module 105 and the playback history is not sent, it is acceptable that the CAS module 105 determines that an invalid playback process is performed by the renderer 102 and operates so as to stop the subsequent decryption of the ECM data and output of the scrambling keys to the renderer 102. If doing so, it is possible to prevent invalid preview playback that is performed by the renderer 102 and exceeds the playback-permitted time. Alternatively, it is acceptable that, in the same manner as in FIG. 6, the CAS module 105 uses the timer unit to measure an actual time, and detects an invalid process performed by the renderer 102 by comparing the measurement result with the playback remaining time.

In addition, the playback time calculation unit 111 according to the above-described embodiment detects an invalid preview playback by comparing the actual time measured with the playback remaining time, but it is acceptable to detect an invalid preview playback by comparing the actual time and the playback history.

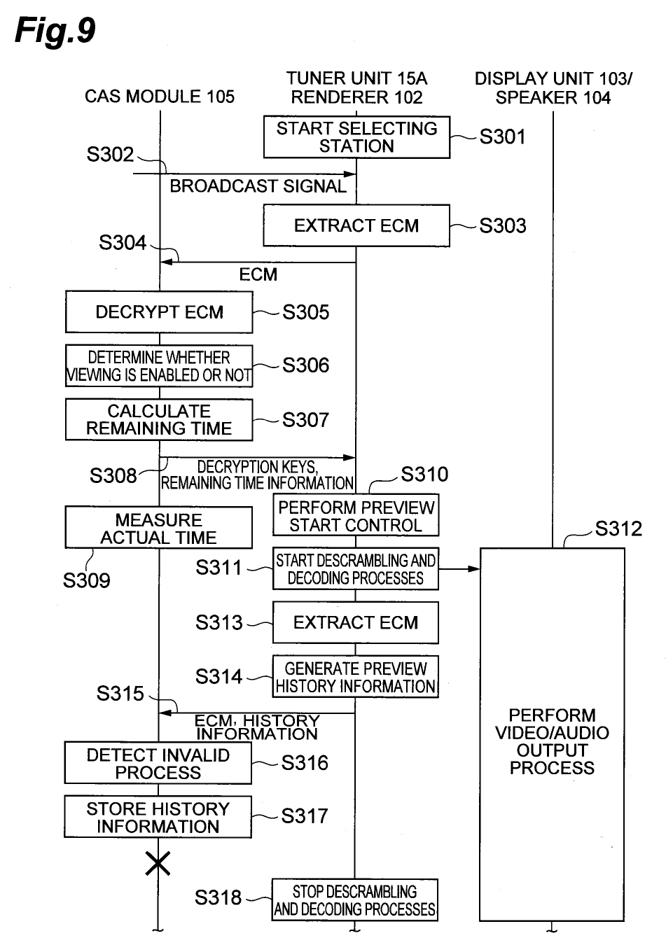

FIG. 9 is a sequence diagram illustrating abnormal operation at the time of preview execution of a pay broadcast program in the broadcast receiving terminal 1 in such a case. To begin with, in the same manner as the processes at steps S201 to S308 in FIG. 8, in accordance with reception of a broadcast signal by the tuner unit 15A, scrambling keys and playback remaining time information are output from the CAS module 105 to the renderer 102 (steps S301 to S308). At the same time as the output of the scrambling keys and the playback remaining time information, measurement of an elapsed time is started using the timer unit 112 of the CAS module 105 (step S309). Subsequently, in the same manner as the processes at steps S209 to S214 in FIG. 8, preview playback by the renderer 102, and output of the ECM data updated and a playback history from the renderer 102 to the CAS module 105 are performed (steps S310 to S315). In response to this, the playback time calculation unit 111 of the CAS module 105, at the timing when the playback history is sent, by checking the elapsed time measured by the timer unit 112 against a playback time period identified from the playback history, and determining whether the elapsed time exceeds the playback time period or not, detects an invalid preview playback performed by the renderer 102 (step S316). As a result of this determination, when the elapsed time exceeds the playback time period, the playback time calculation unit 111, by setting the playback time that the playback history indicates to the upper limit and storing it, aborts the subsequent output of the scrambling keys Ks_odd and Ks_even to the renderer 102 (step S317). Accordingly, a descrambling process and a decoding process that are performed by the renderer 102 and are invalid are stopped (step S318).

In addition, it is acceptable that, at step S304 and step S315, the CAS module 105 receives also classification information indicating a model of a broadcast receiving terminal from the renderer 102 and, at step S316, the CAS module 105, when detecting preview playback that is invalid because of the excess of the actual time thereof over the playback history or the playback-permitted time, stores therein the classification information acquired from the renderer 102, and operates so as to prohibit output of the scrambling keys for the renderer 102 corresponding to the classification information in the subsequent process. In this case, at the time of the subsequent ECM decryption, based on whether the classification information is prohibited or not, the CAS module 105 determines whether to stop the output of the scrambling keys. Alternatively, when detecting an invalid renderer at step S316, it is acceptable to do so based on whether preview playback is prohibited for the classification information.

In addition, although the playback time calculation unit 111 according to the above-described embodiment calculates the total time of already played back periods in a unit of program ID for identifying a broadcast program included in the ECM data from the history information storage unit 113 and, from the total time thus calculated, calculates the playback remaining time information, it is acceptable to calculate the total time for each set of a plurality of program IDs such as a program group broadcasted from the same broadcast channel and, from the total time, calculate the remaining time information. For example, when the history information as depicted in FIG. 4 is stored, the playback time calculation unit 111 may calculate the playback remaining time information for each of the broadcasting station “A#1” to which a plurality of program IDs “11” and “12” belong. In this case, if a program ID is set to a specific value for each of services, a specific value for each of channels, and a specific value for a plurality of channels, only using the program ID makes it possible to implement a diversity control mode such as enabling preview playback only for a specific program or limiting a preview playback time for an entire channel.

Herein, the CAS module 105 according to the above-described embodiment is assumed to be an IC card as hardware to be implemented, but is acceptable to be made of a program downloaded to the broadcast receiving terminal 1, a program implemented in the broadcast receiving terminal 1 in advance, an IC circuit board or the like, or a combination thereof.

Herein, it is preferred that the history information storage means adds, to the history information on the playback data, program information indicating a program or a program group to which the playback data belongs, and stores them therein, the calculation means calculates the playback remaining time information for each of programs or program groups that the program information indicates, and the playback control means uses the playback remaining time information calculated for each of the programs or the program groups to control decryption of the playback data. If doing so, the playback time is made controllable for each of the programs to which the playback data belongs or the program groups such as a broadcast channel, and accordingly playback control in accordance with the provision form of services on the side of a broadcast data provider is implemented.

In addition, it is preferred that the key information processing unit further has measuring means for measuring an elapsed time after sending the key information to the playback data processing unit, and by checking the history information generated by the decrypting means against the elapsed time, detects an invalid playback process on the playback data, and aborts delivery of the key information to the playback data processing unit when the invalid playback process is detected. Use of this structure disables, when an invalid playback process performed by the playback data processing unit is detected, decryption of the playback data, making it possible to surely prevent an invalid playback process performed by the broadcast receiving terminal.

Furthermore, it is preferred that the key information processing unit further has measuring means for measuring an elapsed time after sending the key information to the playback data processing unit and, after receiving classification information on the broadcast receiving terminal from the playback data processing unit, by checking the history information generated by the decrypting means against the elapsed time, detects an invalid playback process on the playback data, and aborts delivery of the key information to the playback data processing unit corresponding to the classification information when the invalid playback process is detected. If doing so, when an invalid playback process performed by a specific model of broadcast receiving terminal is detected, decryption of the playback data is disabled, making it possible to effectively prevent an invalid playback process performed by the specific model of broadcast receiving terminal.

### INDUSTRIAL APPLICABILITY

The present invention is an invention that is intended for application to a broadcast receiving terminal and a broadcast receiving method and, without being affected by the update frequency of a decryption key for broadcasted playback data, can implement playback control in accordance with actual playback time.

### REFERENCE SIGNS LIST

1 . . . broadcast receiving terminal, 102 renderer (playback data processing unit), 105 . . . CAS module (key information processing unit), 107 . . . descrambling unit (decrypting means), 108 . . . decoding unit (decrypting means), 109 . . . preview control unit (playback control means), 111 . . . playback time calculation unit (calculation means), 112 . . . timer unit (measuring means), 113 . . . history information storage unit (history information storage means)

1: A broadcast receiving terminal comprising:
a key information processing unit that receives a broadcast signal and acquires key information out of the broadcast signal; and
a playback data processing unit that decrypts playback data included in the broadcast signal by using the key information and plays resulting data back, wherein
the key information processing unit includes:
history information storage means for storing history information on playback of the playback data by the playback data processing unit, and
calculation means for acquiring the key information and playback time information indicating a time during which playback of the playback data is possible that are included in the broadcast signal, calculating playback remaining time information indicating a remaining time during which playback of the playback data is possible based on the playback time information and the history information, and sending the key information and the playback remaining time information to the playback data processing unit, and
the playback data processing unit includes:
decrypting means for decrypting the playback data included in the broadcast signal by using the key information sent from the calculation means and playing it back, and sending history information on this playback to the key information processing unit, and
playback control means for controlling the decrypting means so as to decrypt the playback data only for the time indicated by the playback remaining time information sent from the calculation means.

2: The broadcast receiving terminal according to claim 1, wherein
the history information storage means adds, to the history information on the playback data, program information indicating a program or a program group to which the playback data belongs, and stores resulting information therein,
the calculation means calculates the playback remaining time information for each of programs or program groups that the program information indicates, and
the playback control means uses the playback remaining time information calculated for each of the programs or the program groups to control decryption of the playback data.

3: The broadcast receiving terminal according to claim 1, wherein
the key information processing unit further includes measuring means for measuring an elapsed time after sending the key information to the playback data processing unit, and
by checking the history information generated by the decrypting means against the elapsed time, detects an invalid playback process on the playback data, and aborts delivery of the key information to the playback data processing unit when the invalid playback process is detected.

4: The broadcast receiving terminal according to claim 1, wherein
the key information processing unit further includes measuring means for measuring an elapsed time after sending the key information to the playback data processing unit,
after receiving classification information on the broadcast receiving terminal from the playback data processing unit, by checking the history information generated by the decrypting means against the elapsed time, detects an invalid playback process on the playback data, and
aborts delivery of the key information to the playback data processing unit corresponding to the classification information when the invalid playback process is detected.

5: A broadcast receiving method in a broadcast receiving terminal that comprises a key information processing unit that receives a broadcast signal and acquires key information out of the broadcast signal and a playback data processing unit that decrypts playback data included in the broadcast signal by using the key information and plays resulting data back, the broadcast receiving method comprising:
a history information storage step of, by the key information processing unit, storing history information on playback of the playback data by the playback data processing unit;
a calculation step of, by the key information processing unit, acquiring the key information and playback time information indicating a time during which playback of the playback data is possible that are included in the broadcast signal, calculating playback remaining time information indicating a remaining time during which playback of the playback data is possible based on the playback time information and the history information, and sending the key information and the playback remaining time information to the playback data processing unit;
a decrypting step of, by the playback data processing unit, decrypting the playback data included in the broadcast signal by using the key information sent from the key information processing unit and playing resulting data back, and sending history information on this playback to the key information processing unit; and
a playback control step of, by the playback data processing unit, performing control so as to decrypt the playback data only for the time indicated by the playback remaining time information sent from the key information processing unit.

6: The broadcast receiving terminal according to claim 2, wherein
the key information processing unit further includes measuring means for measuring an elapsed time after sending the key information to the playback data processing unit, and
by checking the history information generated by the decrypting means against the elapsed time, detects an invalid playback process on the playback data, and aborts delivery of the key information to the playback data processing unit when the invalid playback process is detected.

7: The broadcast receiving terminal according to claim 2, wherein
the key information processing unit further includes measuring means for measuring an elapsed time after sending the key information to the playback data processing unit,
after receiving classification information on the broadcast receiving terminal from the playback data processing unit, by checking the history information generated by the decrypting means against the elapsed time, detects an invalid playback process on the playback data, and
aborts delivery of the key information to the playback data processing unit corresponding to the classification information when the invalid playback process is detected.
